(19) United States
(12) Patent Application Publication
(10) Pub. No.: US 2018/0088665 A1
(43) Pub. Date: Mar. 29, 2018

(54) EYE TRACKING SELECTION VALIDATION

(71) Applicant: Lenovo (Singapore) Pte. Ltd., Singapore (SG)

(72) Inventors: Nathan J. Peterson, Oxford, NC (US); Russell Speight VanBlon, Raleigh, NC (US); Arnold S. Weksler, Raleigh, NC (US); John Carl Mese, Cary, NC (US)

(21) Appl. No.: 15/276,130

(22) Filed: Sep. 26, 2016

(51) Int. Cl. G06F 3/01; G06F 3/0488; G06F 3/041; G06F 3/03

(52) U.S. Cl. CPC G06F 3/013; G06F 3/04883; G06F 3/04842; G06F 3/0304; G06F 3/0418

(57) ABSTRACT

One embodiment provides a method, including: capturing, using an eye tracking system of an electronic device, image data; identifying, using the eye tracking system, a location of user gaze; detecting, using an input device of the electronic device, user input associated with an actionable area of the electronic device; determining, using a processor, that the location of user gaze and the actionable area of the electronic device are not associated with substantially the same location of the electronic device; and in response to the determining, disregarding the user input to the actionable area. Other aspects are described and claimed.

### BACKGROUND

Electronic devices such as desktop computers, laptop computers, tablets, smart phones, etc., are utilized to perform various tasks. As part of this functionality, user input devices are provided, such as pointing devices, touch screens, digitizers, voice input systems, gesture detection systems, etc., to receive and act upon user inputs.

In order to perform some tasks, a user may need to interact with or handle an electronic device and inadvertently trigger unintended functions via inadvertent input detected by a user input device. For example, it is common for a user to have difficulty with providing inadvertent input into a touch screen, e.g., while watching a video and holding the electronic device at or near the touch screen.

Various filtering algorithms have been introduced in an effort to address inadvertent input. For example, palm check filters are utilized to reduce inadvertent input to a touch screen.

### BRIEF SUMMARY

In summary, one aspect provides a method, comprising: capturing, using an eye tracking system of an electronic device, image data; identifying, using the eye tracking system, a location of user gaze; detecting, using an input device of the electronic device, user input associated with an actionable area of the electronic device; determining, using a processor, that the location of user gaze and the actionable area of the electronic device are not associated with substantially the same location of the electronic device; and in response to the determining, disregarding the user input to the actionable area.

Another aspect provides an electronic device, comprising: an input device; an eye tracking system; a processor; and a memory that stores instructions executable by the processor to: capture, using the eye tracking system, image data; identify, using the eye tracking system, a location of user gaze; detect, using the input device, user input associated with an actionable area of the electronic device; determine that the location of user gaze and the actionable area of the electronic device are not substantially related; and thereafter disregarding the user input to the actionable area.

A further aspect provides a product, comprising: a storage device that stores code, the code being executable by a processor and comprising: code that captures, using an eye tracking system of an electronic device, image data; code that identifies, using the eye tracking system, a location of user gaze; code that detects, using an input device of the electronic device, user input associated with an actionable area of the electronic device; code that determines, using a processor, that the location of user gaze and the actionable area of the electronic device are not substantially related; and code that thereafter disregards the user input to the actionable area.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of eye tracking based selection validation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

It is common for a user to have difficulty with providing inadvertent input. For example, even after many years of having touch devices, users still tend to have problems with accidental click actions. This happens easily when handing a device to someone else to look at a photo, when children that are just holding the devices along the edges as they are watching a video, etc.

There are a lot of techniques used for filtering inadvertent input. Each technique tends to rely on analyzing the nature of the input itself. For example, palm rejection filters may be applied to reject large areas of input detected while writing on a device with a stylus or pen. Moreover, there are not very many filter algorithms for general accidental clicking, e.g., on an actionable element such as a hyperlink displayed on a screen, a soft button displayed on a screen, etc.

An embodiment uses a combination of eye tracking and touch location to determine whether a person is actually attempting to make a selection, e.g., of an actionable element or area on the screen. If a user isn't looking at or near an item or area including the actionable item or element, e.g., displayed on the screen, while touching the screen, or shortly before or shortly thereafter, the user is probably not trying to select it.

The processing of the eye tracking data and the user input data may be applied to many different types of actionable elements or areas of the electronic device, and consequently to many different input modes. For example, an embodiment may act to filter out unwanted touch inputs, e.g., provided to a link or other actionable element displayed on a touch screen based on eye tracking data. An embodiment may also filter out other touch events, e.g., swiping actions provided to a touch screen, based on eye tracking data. An embodiment may filter out touch events to areas of the electronic device, e.g., physical buttons, etc., based on eye tracking data. Moreover, an embodiment may filter out non-touch based events, e.g., provided with a pointing device such as a physical mouse, based on eye tracking data.

A few non-limiting examples are as follows. An embodiment may act, on the basis of eye tracking data, to filter out unwanted touch events during the watching of a video in widescreen mode on a tablet. For example, if a user holds the electronic device with his or her thumbs hitting the top edges of the screen, inadvertently selecting options in the video player, an embodiment may disregard these inputs if the eye tracking data does not indicate that the user is looking at his or her thumbs/the area near the options in the video player.

As another example, if an event comes in on a user's phone, e.g., a text message is received, this sometimes will turn the touch screen on. If the user is simply holding the phone while this occurs, inadvertent input (e.g., finger or palm input) may select things on the screen by accident. However, an embodiment acts to reconcile these inadvertent inputs with eye tracking data, e.g., to determine that the user is not looking at the phone and thus that these inputs should be disregarded.

As another example, when a smart phone rings, a user may accidently hang up the call while trying to retrieve the smart phone from a pocket. However, an embodiment will disregard these inputs given that eye tracking data is not available to confirm that the user is focusing on the smart phone or a particular part of the smart phone, e.g., a soft button, a physical button, etc.

As a further example, often certain users, e.g., children, don't understand why, when they are just holding a device with a touch screen, the screen changes in response to the touch inputs that are provided by grasping the device. An embodiment may assist such users by filtering out/disregarding such touch inputs unless eye tracking data confirms that the user is focusing on/looking at the area at which the input is being provided.

The illustrated example embodiments will be best understood by reference to the figures. The following description is intended only by way of example, and simply illustrates certain example embodiments.

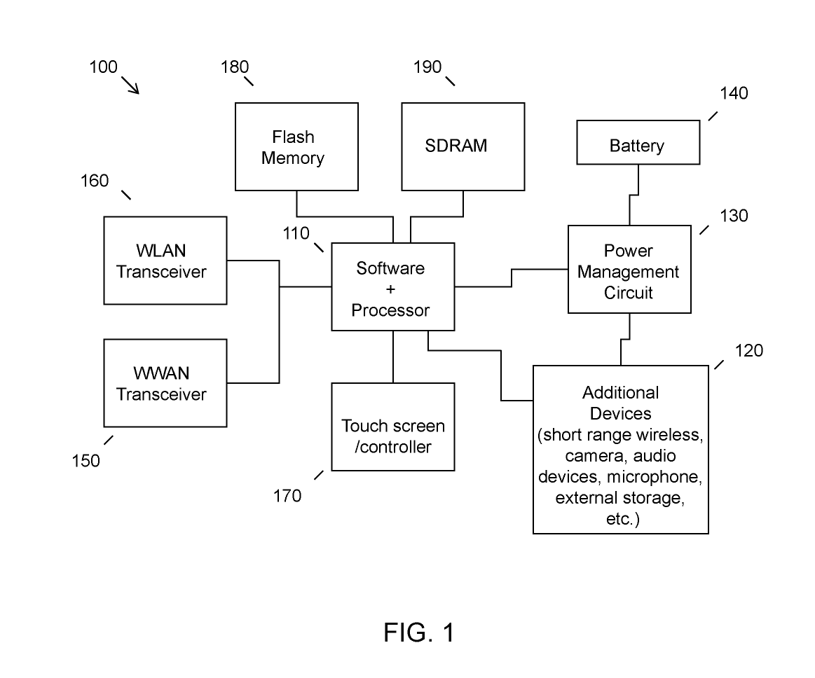

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., a microphone for receiving voice commands, a camera for receiving image data including gestures, etc. System 100 often includes a touch screen 170 for data input and display/rendering. System 100 also typically includes various memory devices, for example flash memory 180 and SDRAM 190.

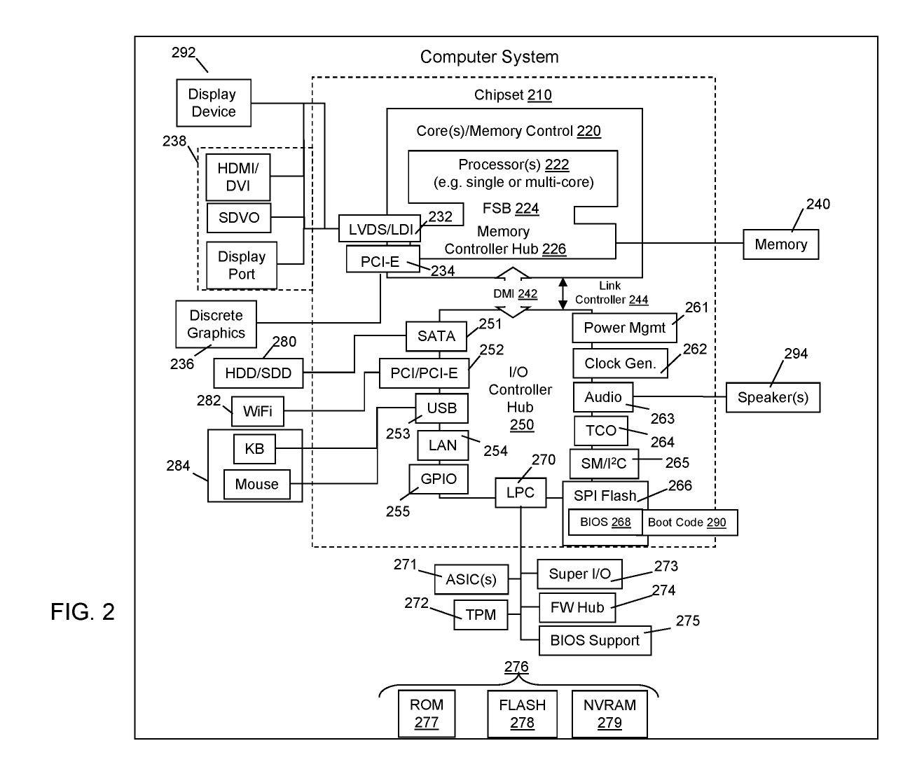

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, biometric data capture device, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in electronic devices that respond to user inputs provided to various input devices. In an embodiment, the user inputs are reconciled with data from an eye tracking system, e.g., that resolves the location of a user's gaze based on image data collected via a camera or other imaging device. This permits an association to be made between a user's input, e.g., provided to a touch screen, provided using a mouse, etc., and the user's gaze location.

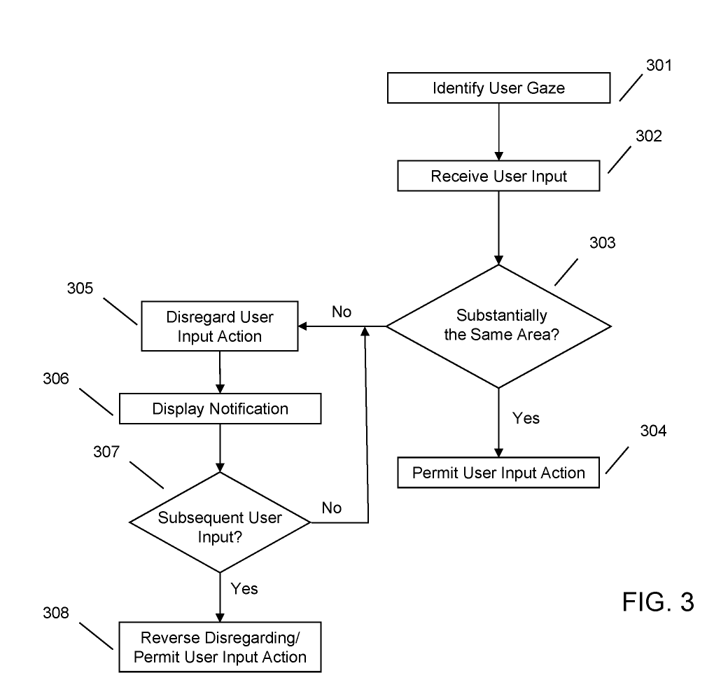

As illustrated by way of example in FIG. 3, an embodiment captures, using an eye tracking system of an electronic device, image data of the user. This image data may be captured on an ongoing basis, e.g., by an integrated camera of the electronic device that provides image data to a gaze or eye tracking subsystem. An embodiment uses the eye tracking system to identify, at 301, a location of user gaze. For example, the eye tracking system may provide two-dimensional (x, y) coordinates of an area with which the user's focus is associated. Thus, an embodiment may detect that the user is looking at a particular part of the electronic device at 301, e.g., looking at the center of the display screen.

At 302, an embodiment detects, e.g., using an input device of the electronic device, user input associated with an actionable area of the electronic device. For example, a user may grasp the electronic device using a hand and provide touch input to a lateral edge of the touch screen. This area associated with the user input may likewise be associated with two-dimensional (x, y) coordinates.

Other examples of receipt of user input at 302 include, but are not limited to, detecting a mouse click on an actionable element, such as a hyperlink, a soft button or control, etc., detecting voice input that is associated with an actionable item or function, such as detecting the words “scroll,” “pause,” or “stop,” etc., detecting contact with a physical button in a bezel of the screen, etc.

An embodiment determines, at 303, that the location of user gaze, identified at 301, and the actionable area of the electronic device, e.g., the physical or virtual location associated with the user input, are not associated with substantially the same location of the electronic device. For example, an embodiment may determine at 303 that the user is looking at the center region of the display screen but has provided touch input to an edge or a corner region of the touch screen.

If the location of the user gaze and the location of the actionable area associated with the user input are correlated, e.g., are substantially the same location, an embodiment may permit the user input, as illustrated at 304.

However, if it is determined at 303 that the location of the user gaze and the location of the actionable element associated with the user input are not substantially the same, an embodiment may disregard or filter out the user input, as illustrated at 305. Thus, for a user that is touching the touch screen at an edge (e.g., scroll bar, media player soft button location, etc.) but is not looking at this area, or near this area, an embodiment may disregard these inputs as inadvertent.

An embodiment may communicate to the user, at 306, that the user input is disregarded. For example, an embodiment may display a notification that the user input is being disregarded at 306. This permits the user to provide subsequent for further input, as illustrated at 307, e.g., which might be used to confirm the original user input was intentional, at illustrated at 308. For example, a user may provide the same or substantially the same input within a predetermined time frame (e.g., within 10 seconds), which acts to confirm the input was intentional.

Therefore, an embodiment may reverse the disregarding implemented at 305, e.g., by retrieving the user input data provided at 303 from storage and acting upon the user input, by acting on the subsequent or further input directly, etc. Otherwise, an embodiment may maintain the filtering of the user input provided at 303.

It should be noted that actionable area might be located on a screen of the electronic device, e.g., the actionable area may include a displayed element such as a soft button, a scroll bar, a hyperlink, etc.

The user input received at 302 likewise might be provided from a variety of sources. For example, the user input received at 304 might include touch input provided to a display screen, a physical button, a digitizer, a mouse, a touch pad, etc.

In order to determine, at 303, that the location of user gaze and the actionable area of the electronic device are or are not associated with substantially the same location of the electronic device, an embodiment may assign an area to each input (i.e., location of user gaze and the location (physical or virtual location) of the actionable element or area. For example, an embodiment associates two-dimensional (x, y) coordinates derived from the image data, i.e., those of the user gaze location, with a first surface area of the electronic device. Likewise, an embodiment associates two-dimensional (x, y) coordinates derived from the user input with a second surface of the electronic device, i.e., the location of the actionable element or area of the electronic device. It will be understood that in some cases, e.g., touch based user input of an element displayed on a touch screen, that the location will be a physical surface area directly associated with the touch input. In other cases, e.g., a mouse click on a hyperlink, a gesture or voice input that selects a hyperlink, that the location will be a virtual surface area indirectly related with the user input, i.e., the mouse click, the gesture, etc.

This permits an embodiment to determine, at 303, that the first surface area and the second surface area overlap or do not overlap. The determination that the first surface area and the second surface area overlap or do not overlap may include determining that the first surface area and the second surface area overlap or do not overlap (are separated) by at least a predetermined amount. The predetermined amount may be chosen by the user or set by default in an attempt to appropriately tune the filtering of inputs. The predetermined amount may be changed, as may be the surface area that is associated with the user input and/or the location of user gaze, i.e., in order to filter more or less user input.

Therefore, an embodiment provides for improved user input filtering based on the data of an eye tracking system. The user is therefore able to more confidently handle the device, e.g., grasp it without regard to area of contact, while also avoiding unwanted input detection.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium, such as a non-signal storage device, that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
capturing, using an eye tracking system of an electronic device, image data;
identifying, using the eye tracking system, a location of user gaze;
detecting, using an input device of the electronic device, user input associated with an actionable area of the electronic device;
determining, using a processor, that the location of user gaze and the actionable area of the electronic device are not associated with substantially the same location of the electronic device; and
in response to the determining, disregarding the user input to the actionable area.

2. The method of claim 1, wherein the actionable area is located on a screen of the electronic device.

3. The method of claim 1, wherein the actionable area comprises a displayed element.

4. The method of claim 1, wherein the user input comprises touch input.

5. The method of claim 1, wherein the determining that the location of user gaze and the actionable area of the electronic device are not associated with substantially the same location of the electronic device comprises:
associating two-dimensional coordinates derived from the image data with a first surface area of the electronic device;
associating two-dimensional coordinates derived from the user input with a second surface of the electronic device; and
determining that the first surface area and the second surface area do not overlap.

6. The method of claim 5, wherein the determining that the first surface area and the second surface area do not overlap comprises determining that the first surface area and the second surface area do not overlap at least a predetermined amount.

7. The method of claim 1, further comprising communicating to a user that the user input is disregarded.

8. The method of claim 7, further comprising storing the user input.

9. The method of claim 8, further comprising:
receiving further user input; and
reversing the disregarding.

10. The method of claim 9, wherein the reversing comprises acting on the user input.

11. An electronic device, comprising:
an input device;
an eye tracking system;
a processor; and
a memory that stores instructions executable by the processor to:
capture, using the eye tracking system, image data;
identify, using the eye tracking system, a location of user gaze;
detect, using the input device, user input associated with an actionable area of the electronic device;
determine that the location of user gaze and the actionable area of the electronic device are not substantially related; and
thereafter disregarding the user input to the actionable area.

12. The electronic device of claim 11, further comprising a screen, wherein the actionable area is located on the screen of the electronic device.

13. The electronic device of claim 11, wherein the actionable area comprises a displayed element.

14. The electronic device of claim 11, wherein the input device comprises a touch screen, and further wherein the user input comprises touch input.

15. The electronic device of claim 11, wherein the processor determines that the location of user gaze and the actionable area of the electronic device are not associated with substantially the same location of the electronic device by:
associating two-dimensional coordinates derived from the image data with a first surface area of the electronic device;
associating two-dimensional coordinates derived from the user input with a second surface of the electronic device; and
determining that the first surface area and the second surface area do not overlap.

16. The electronic device of claim 15, wherein the processor determines that the first surface area and the second surface area do not overlap at least a predetermined amount.

17. The electronic device of claim 16, wherein the instructions are further executable by the processor to communicate to a user that the user input is disregarded.

18. The electronic device of claim 11, wherein the location of user gaze and the actionable area of the electronic device are substantially related if the location and of user gaze and the actionable area of the electronic device are associated with substantially the same location of the electronic device.

19. The electronic device of claim 17, wherein the instructions are further executable by the processor to store the user input;
receive further user input; and
reverse the disregarding.

20. A product, comprising:
a storage device that stores code, the code being executable by a processor and comprising:
code that captures, using an eye tracking system of an electronic device, image data;
code that identifies, using the eye tracking system, a location of user gaze;
code that detects, using an input device of the electronic device, user input associated with an actionable area of the electronic device;
code that determines, using a processor, that the location of user gaze and the actionable area of the electronic device are not substantially related; and
code that thereafter disregards the user input to the actionable area.
